(19) United States
(12) Patent Application Publication
(10) Pub. No.: US 2010/0098371 A1
(43) Pub. Date: Apr. 22, 2010

(54) LOAD-BEARING PRODUCTS AND METHOD FOR MAKING SAME

(76) Inventors: Larry L. Perkins, Midland, TX (US); Tim Kriegshauser, Midland, TX (US)

Correspondence Address: CARSTENS & CAHOON, LLP, P O BOX 802334, DALLAS, TX, 75380, US

(21) Appl. No.: 12/501,307

(22) Filed: Jul. 10, 2009

Related U.S. Application Data
(63) Continuation-in-part of application No. 12/365,781, filed on Feb. 4, 2009.
(60) Provisional application No. 61/106,778, filed on Oct. 20, 2008.

(51) Int. Cl. F16C 33/00; B23P 17/00

(52) U.S. Cl. 384/627; 29/527.2

(57) ABSTRACT

A method for the construction of load-bearing products. Load-bearing and substantially fluid impenetrable products are constructed for protection against leaks and provide for simple and efficient transportation and set-up. Also disclosed is a load bearing product having a substrate such as an expanded polystryrene encapsulated by an elastomer such as a polyurea.

### CROSS-REFERENCE TO RELATED APPLICATION

This application claims the benefit of and priority to a U.S. patent application Ser. No. 12/365,781 filed Feb. 4, 2009, the technical disclosure of which is hereby incorporated herein by reference.

### BACKGROUND OF THE INVENTION

1. Technical Field

The present invention relates to load-bearing structures and the method for making same. The encapsulated materials of the present invention are useful in any number of applications involving the need for load-bearing support, providing a replacement for traditional construction products.

2. Description of Related Art

Load-bearing structures are central in construction activities, either as parts of the construction itself as structural support, as aids for the construction work, or as both. The primary purpose of a “load-bearing structure” is to carry weight, give support to other parts in a construction, and/or to transmit dynamic forces. The materials most often used to construct load-bearing structures are typically manufactured from rigid and stiff materials such as concrete blocks, wood, steel, stone, metal, or brick, or combinations thereof, and can be found in various shapes, forms and sizes.

Traditional load-bearing construction materials can absorb the hazardous substances of their environments only to be later disposed of in an ever-increasing amount of landfills. Even the use of more natural alternative such as wood or rocks is increasingly discouraged because it results in depletion of natural resources, ultimately having a negative environmental impact, as they are removed from the environment, and generally not replaced, except for wood which may be replaced very slowly by nature itself. In addition, the weight supporting structures themselves typically comprise a considerable amount of weight in order to provide structural strength, making transport of these materials particularly difficult and costly from both a legal and operational standpoint, and posing a certain amount of risk to those tasked with their transport and shipment.

One alternative to the heavier traditional materials known in the art is lightweight concrete. Lightweight concrete is typically mixed with a variety of light weight aggregates, resulting in about one half the weight of hard structural concrete. However, concretes made with many of the lightweight aggregates are difficult to place and finish. In some mixes, the cement mortar may separate from the aggregate and the aggregate float toward the surface. Consequently, it is necessary to mix lightweight concrete mixtures for long periods of time and frequent adjustment of the processing conditions during manufacturing of the lightweight alternative is not uncommon, for example by grading the aggregates or introducing filler and air-entraining agents. Such difficulties can be complicated and costly in terms of time and materials, and still result in environmental hazards.

Another problem with traditional load-bearing structures is their susceptibility to wear and deterioration can cause the need for replacement, some more frequently than others. Such replacement, especially if it is frequent, is undesirable in terms of expense in the form of materials and labor and in terms of inconvenience. One reason for wear and deterioration of such load-bearing structures is that they are commonly permeable to liquids to a substantial degree, and therefore, are affected by penetration of moisture. In colder climates, this causes further complications and problems if the moisture subsequently freezes, thus stressing and possibly cracking portions of the load-bearing structures.

Consequently, there is a need for an improved load-bearing structure that can serve as a more useful and green alternative to the traditional construction materials currently in use. In light of growing environmental trends, it is desirable that the load-bearing structure be manufactured and used with little to no negative environmental impact, while providing for green waste when necessary. There is also a need for an improved load-bearing structure that can be manufactured and transported more cost efficiently and conveniently while providing for increased safety to construction workers and engineering crews. The supporting structures should be light enough to transport quickly and safely yet strong enough to support large amounts of weight. In addition, there is a need for a load-bearing structure that costs less in terms of maintenance, enduring longer than other similar structures made of traditional construction materials. Finally, there is a need for a load-bearing structure substantially impermeable to moisture, liquids, and other natural elements to prevent the proliferation of bacteria that can cause deterioration or erosion of the supporting structure, jeopardizing the structure that it supports and those around it.

### SUMMARY OF THE INVENTION

The present invention provides for an improved load-bearing product and the method of its manufacture, which provide for improved environmental remediation. By encapsulating a substrate material with an elastomer, a substantially nonporous load-bearing product is created. The product is surprisingly strong and structurally sound under large amounts of weight. It is also substantially impervious to liquids and moisture, eliminating the issue of cradle to grave legacies that exist with other common structural materials.

In one embodiment, a substrate material is designed or shaped as a base or support for any desired structure capable of being loaded. In another embodiment, more than one component or portion is designed or shaped from the substrate material to form the base or support for the desired structure. Once the designing step is completed, an elastomer coating is applied to the designed substrate to form the load-bearing product of the present invention. Preferably, the application is performed using specialized equipment that uses high temperatures and high pressures for mixing directly in an impingement mix spray gun. After application, each encapsulated substrate comprises an average coverage of at least approximately 50 mils and most preferably, at least approximately 60 mils of the modified elastomer In one embodiment, the substrate material chosen as the starting material to be encapsulated is expanded polystyrene (EPS). EPS materials provide for biodegradable structures and allow for steam cleaning for removal of the contaminating hydrocarbons, ensuring the environmentally safe disposal of the coated load-supporting substrate, or load-bearing product, if it becomes necessary.

When the substrate is designed as more than one component, each designed component of the substrate is individually coated with the elastomer to create at least one seam between two properly aligned and adjacent substrate components. The seam between two adjacent components allows any liquids to pass through the support structure such that no corrosion of any surrounding construction materials is experienced as a result of any standing fluids. Optionally, where more than one portion is used, the portions are fastened together around the outside edges or peripheries and subsequently held together under weight from the device(s) the coated materials are designed to support. The fastener can then be removed, if desired, resulting in the surprising strong and load-bearing product of the present invention.

The improved load-bearing support product of the present invention can be designed to fit and function with any type of base, vessel, unit, or structure to sustain the desired weight. Thus, while described below with respect to specific applications, one skilled in the art, having read this disclosure, will recognize that this product can be used in an unlimited amount of applications requiring load-bearing support. Therefore, the present invention relates to any such application. Other aspects, embodiments and features of the invention will become apparent from the following detailed description of the invention when considered in conjunction with the accompanying drawings. The accompanying figures are schematic and are not intended to be drawn to scale. In the figures, each identical or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is an illustration of one embodiment of the present invention as it applies to a storage tank base for use as a support structure.

FIG. 2 is a side perspective view of the tank base as seen in FIG. 1.

FIG. 3 is a side perspective view of another embodiment of a support structure of the present invention.

FIG. 4 is a top perspective view of another embodiment of a support structure.

FIG. 5 is a perspective view of another embodiment of a load-bearing product of the present invention.

FIG. 6 is an illustration of another embodiment of a load-bearing product of the present invention for use when applied to stairs or steps.

FIG. 7 is an illustration of a perspective view of another embodiment of the load-bearing support product of the present invention as applied to a pipe or post support.

FIG. 8a is an illustration of a perspective view of another embodiment of the present invention as applied to a pipe or post support.

FIG. 8b is an illustration of a perspective view of another embodiment of the present invention as applied to a pipe or post support.

FIG. 9 depicts a side perspective view of another embodiment of the present invention when supporting another type of containment or storage reservoir.

FIG. 10 depicts a side perspective view of another embodiment of the load-bearing support product of the present invention supporting another type containment or storage reservoir.

FIG. 11 depicts a side perspective view of another embodiment of the present invention designed to support a horizontal storage unit such as a heater treater.

FIG. 12a illustrates a perspective view of another embodiment of the present invention as applied to a foundation of a house.

FIG. 12b illustrates a perspective view of another embodiment of the present invention as applied to a foundation of a house or wall.

FIG. 13 illustrates another embodiment or use of the present invention.

### DETAILED DESCRIPTION

The present invention involves an improved load-bearing structure or product and the method for the construction of same. As used herein, the term “load-bearing product” is meant to include a structure or base that continuously bears or supports the weight and force resting upon it. The present invention is free of volatile organic compounds and 100% inert such that no harmful content is released into the environment, either while in use or if permanently stored in a landfill when replacement becomes necessary. While the figures depict several embodiments or uses for loading the present invention, one skilled in the art, armed with this disclosure, will recognize that the present invention can be designed and applied to any number of systems or structures utilizing load-bearing supports.

The method for constructing the improved products of the present invention will now be further explained in more detail, followed by discussions of the figures, which provide examples of the products to which the invention can be applied. A substrate is first selected as a core material for encapsulation.

In one embodiment, expanded polystyrene (EPS) is used as the substrate. EPS is a polymer with porous structure, currently used in the construction industry as insulation, as non-weight bearing architectural (ornamental) structures, and as floating material. While EPS is known to provide a safe, non-toxic, inert and light alternative, the light weight of EPS in current construction applications limits its continuous, compressing load exposure. The inventors of the present application have found that by combining a substrate with the modified polymer of the present invention, a surprisingly strong, load-bearing product capable of handling long term continuous load conditions is created. Suitable EPS materials are commercially available. Without being bounded by theory, it is believed that the moisture resistance, durability and flexible mechanical properties of EPS combined with the increased chemical resistance of the modified polymer of the present invention provide for a surprisingly high amount of load-bearing support. Further, the high adhesion rate of the modified elastomer helps to encapsulate the substrate and prevents flaking and/or failing under the weight of the structure. While Applicants describe the present invention in terms of EPS, other substrates having a similar compressive strength can also be used.

Having chosen a suitable substrate having this characteristic, the substrate is designed to fit and function as support for a desired structure, which is either loaded or capable of being loaded with high amounts of weight. As used herein, the design step is meant to refer to the cutting, shaping, forming, molding, building or like assembling of the substrate into any custom-made shape or size in the support of, or as a base for, any object or structure. Thus, the substrate is designed according to the size, shape and area with which it will be set up, complementing the structure it will ultimately support. In one embodiment, the custom-shape is made from at least one portion of the chosen substrate. In another embodiment, the custom-shape is made from more than one component of the chosen substrate. As used herein, a component is used to refer to a portion, piece or part of the substrate designed and the terms may be used interchangeably.

Having access to or having created the modified elastomer described above, and once a custom-shape of at least one portion of a substrate is made, each portion of the substrate is individually coated with the modified elastomer. Preferably, the application of the modified elastomer is performed using specialized equipment that uses high temperatures and high pressures for mixing directly in an impingement mix spray gun. In one embodiment, the elastomer is independently applied using a spray device operating at a temperature of approximately 165 degrees Fahrenheit and a pressure of approximately 1800 pounds per square inch (psi) to encapsulate each substrate. The average coverage of the elastomer will be at least approximately 50 mils, and more preferably at least approximately 60 mils coverage. However, one skilled in the art, armed with this disclosure, will recognize that other coverages are also possible depending on the desired compressive strength of the product and the required application. Where more than one portion of a substrate is designed to bear load, the elastomer-covered portions of the substrate are design to fit together with another elastomer-covered portion and can be positioned adjacent to one another, forming at least one seam in between two adjacent portions. The potions may then be optionally bound together with a fastening system while supported the weight of a structure able to hold load(s). The elastomer coating creates a load-bearing product that is impervious to fluid, protecting against contamination of the substrate and deterioration of structure it supports. The coating also allows for ease of cleaning as the material can now be steamed to extract out any hydrocarbon resins. This allows for the environmentally safe disposal of the base if necessary.

Compressive tests were performed to determine the behavior of the materials under compressive loads. As used herein, compressive strength refers to the maximum compressive strength a material is capable of withstanding without rupturing. Table 1, below, evaluates the compression characteristics of raw EPS materials as well as EPS encapsulated with different kinds polyurea in contrast to the encapsulated, load-bearing products of the present invention.

TABLE 1
Flexural test results

| | Maximum | | | Avg. |
|---|---|---|---|---|
| | Load | Modulus | Avg. | Depth |
| Sample | (lbs. force) | of Rupture | Width (in.) | (in.) |
| EPS | 400 | 35 | 5.96 | 6.02 |
| Polyurea 1 | 900 | 70 | 6.12 | 6.15 |
| Polyurea 2 | 1000 | 75 | 6.12 | 6.19 |
| Polyurea 3 | 800 | 60 | 6.22 | 6.12 |
| Polyurea 4 | 700 | 60 | 6.07 | 6.00 |

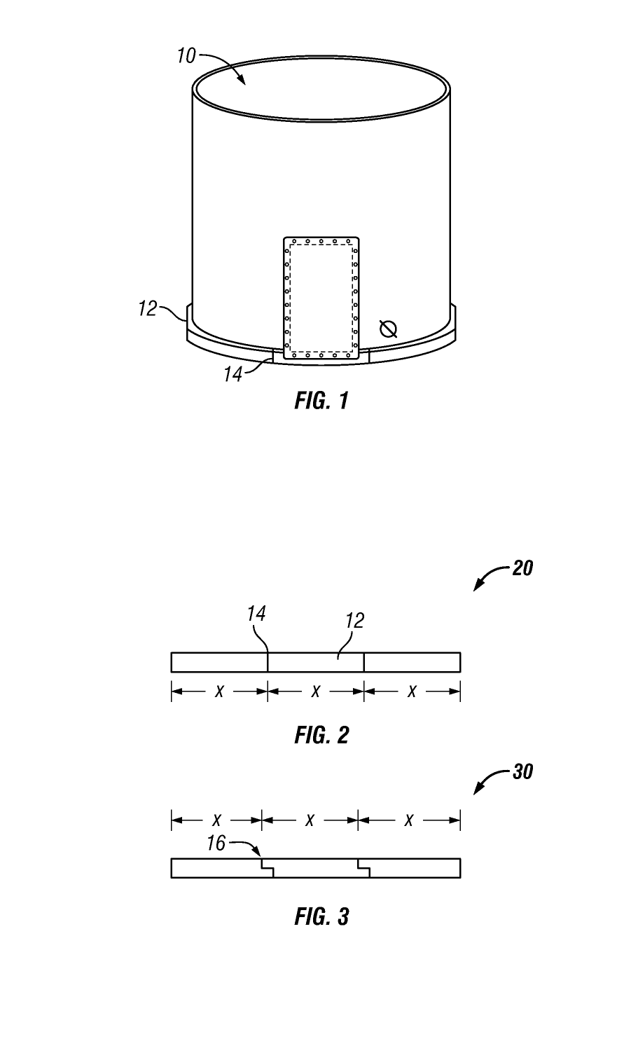

By way of example and without intending to limit the scope of the present invention, the figures will now be discussed. FIGS. 1-2 depict one embodiment of the present invention wherein more than portion of a substrate is designed. This embodiment provides for ease and economically-feasible transport of a load-bearing product and easy installation. Specifically, FIGS. 1-2 illustrate an embodiment of the present invention as applied as a support for a storage tank 10. Structural support for a storage tank 10 is required to prevent the tank bottom from external corrosion. When working with hazardous and corrosive substances, appropriate handling and storage will minimize the risks associated with potential damages to people and the environment. Common hazardous substances include petrol, solvents, household chemicals, acids and alkali compounds, cyanide compounds, and agrichemicals such as pesticides. Like any liquid, storage of large amounts of these substances can prove difficult and care must be taken to support the weight of these stored products, while taking proper precautions to avoid or minimize the harm caused by accidental leakage or incorrect storage and/or disposal.

In this embodiment, more than one portion of the substrate is designed for use beneath a storage tank or unit 10. As best depicted in FIG. 2, three portions 12 of a substrate are designed to accommodate the weight of a loaded structure and aligned adjacent to one another create at least one seam 14 in between two adjacent portions 12. As used herein, the term seam is meant to refer to any line, groove, or ridge formed by joining or fitting together two substrates (or sections) along their edges. The portions 12 can comprise any length x necessary, depending upon the perimeter of the tank or unit 10. Optionally, a 45-foot nylon strap with a cam buckle can be used to secure the coated portions of a substrate around the outer periphery of their edges and hold the portions together until the pressure from the weight of the tank is applied. Once properly aligned, the unit is placed on the load-bearing product, as seen in FIG. 1, and the fastening system may be removed, if desired; or, it may stay in place as the discretion of the owner. As seen in FIG. 1, the storage tank 10 is situated over the center portion of the load-bearing product 20. Preferably, the seams 14 between two adjacent portions 12 are substantially linear as shown in FIG. 2 to allow for any moisture from fluids or standing water to pass through for the prevention of corrosion of the tank; however, as seen in FIG. 3, it is also possible to design adjacent portions to fit or interlock together to create non-linear, interlocking seams 16 to create a load-bearing structure 30, which also helps to hold together the portions 12.

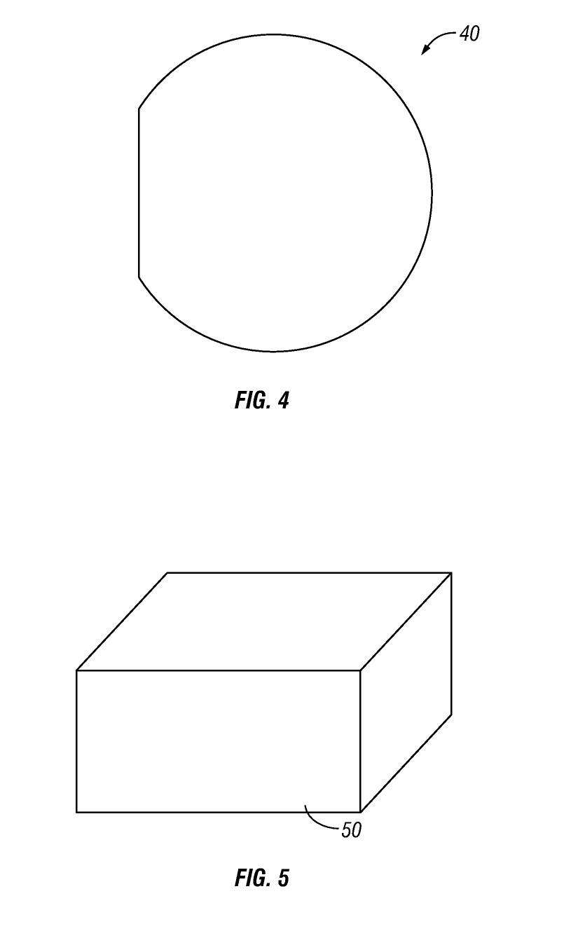

FIG. 4 depicts a top perspective view of another embodiment of a load-bearing structure 40 designed to fit beneath a storage tank such as that depicted in FIG. 1. Preferably, a portion of a substrate is designed to accommodate the structure it is to support. Thus, for example, the flat edge of the circular portion in FIG. 4 takes the plumbing of a loaded structure into account, while providing for ease of entry through a manway. One skilled in the art, having read this disclosure, will recognize that the present invention can be custom fit into an endless plethora of shapes to create a load-bearing structure impervious to fluids.

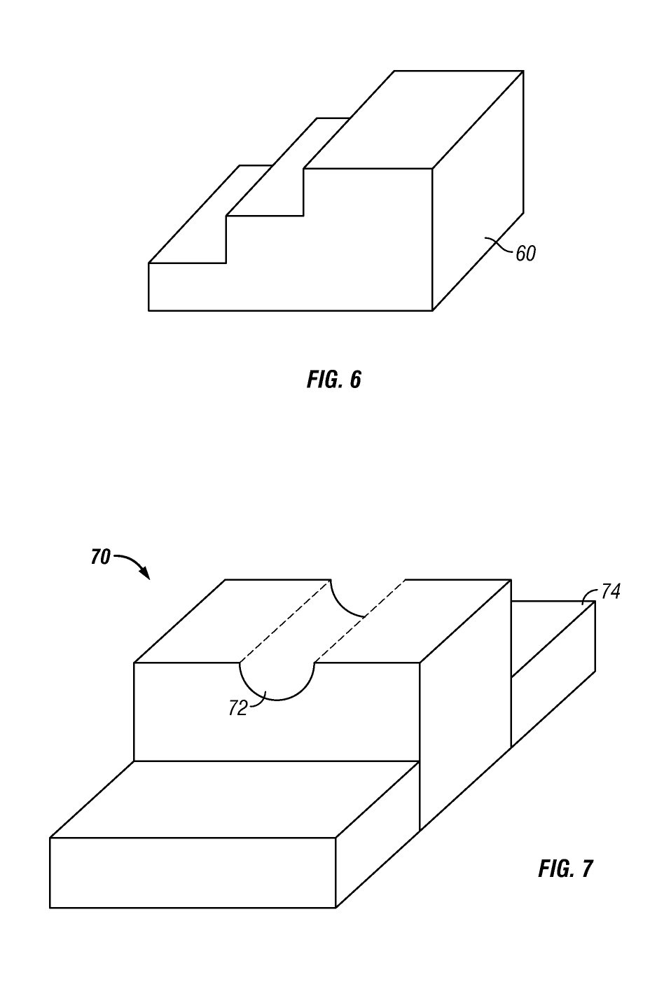

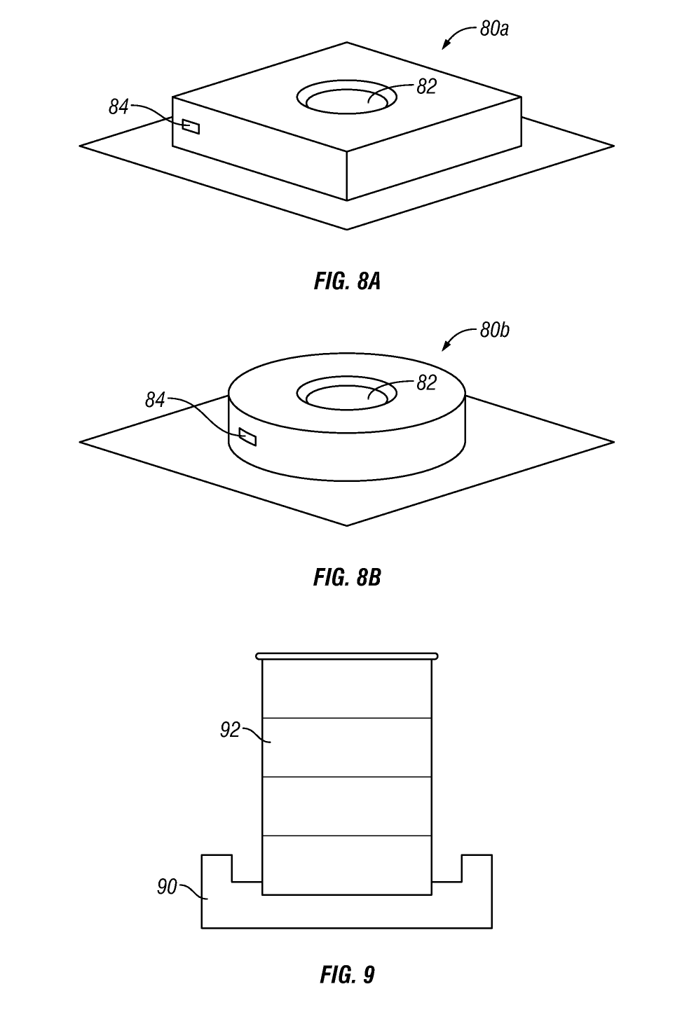

FIGS. 5-13 depict additional embodiments of the load-bearing elastomer encapsulation of the present invention. FIG. 5 is a perspective view of another embodiment of a load-bearing product of the present invention, designed simply as a block or stepping support 50. In FIG. 6, a portion of a substrate is designed and subsequently encapsulated to create a load-bearing set of stairs 60 substantially impervious to liquids. Fluid-resistant stairs 60 are useful, for example, to access read outs for inspection and maintenance of containment areas or otherwise hard to reach areas. FIG. 7 depicts an embodiment of a load-bearing product of the present invention for use as a pipe support 70. The pipe supports 70 can optionally comprise a groove 72 of any desired size according to the diameter associated with a pipe to be supported. Optionally, the elastomer-coated pipe support 70 can also comprise footing 74 if desired. Similarly, in another embodiment depicted in FIGS. 8a and 8b, a pipe stand 80a,b is designed from a suitable substrate. The pipe stand can comprise any size or shape. By way of example and without intending to limit the scope of the invention, as illustrated in FIG. 8a, a load-bearing product 80a can comprise a square shape; or for further example, a load-bearing pipe stand 80b can also comprise a circular or round shape, as shown in FIG. 8b. Optionally, the pipe stand can comprise a groove or indented section 82 within which the end of a pipe will fit. The indented section 82 can comprise any circumference, depending on the size of a pipe to be accommodated and supported. In one embodiment, a Radio Frequency Identification (RFID) Label 84 is attached once the elastomer is applied to keep track and inventory over the products of the present invention.

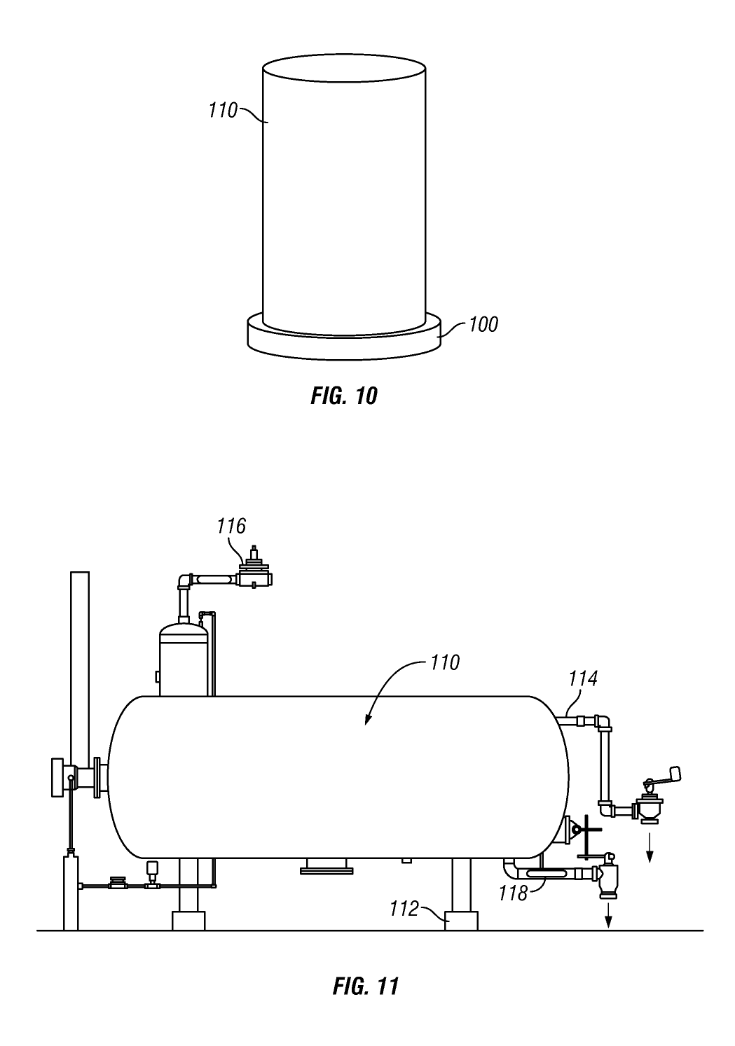

FIG. 9 depicts a side perspective view of another embodiment of the present invention when supporting another type of containment or storage reservoir. By way of example, and without intending to limit the scope of the present invention, a substrate is designed as a contain reservoir 90 to fit in place beneath a chemical drum, storage tank or unit 92. Alternatively, more than one portion of a substrate can be used to form the containment reservoir 92, creating at least one seam as previously discussed with regard to FIGS. 1-3. In FIG. 10, another example for using the present invention is seen wherein a load-bearing product 100 supports the weight of a vertical water heater or like structure 110. Similarly, FIG. 11 depicts an example of the present invention as applied to support posts 112 for a horizontal heater-treater or like fluid-filled structure. Corrosion and plugging is detrimental to the efficiency of operation of various equipment and can also be toxic to the environment in some fields of art. In FIG. 11, the typically concrete support posts 112 can be replaced with the load-bearing products of the present invention such that the support posts 112 are not affected by any leaks from the water outlet 118, oil outlet 114 or gas outlet 116.

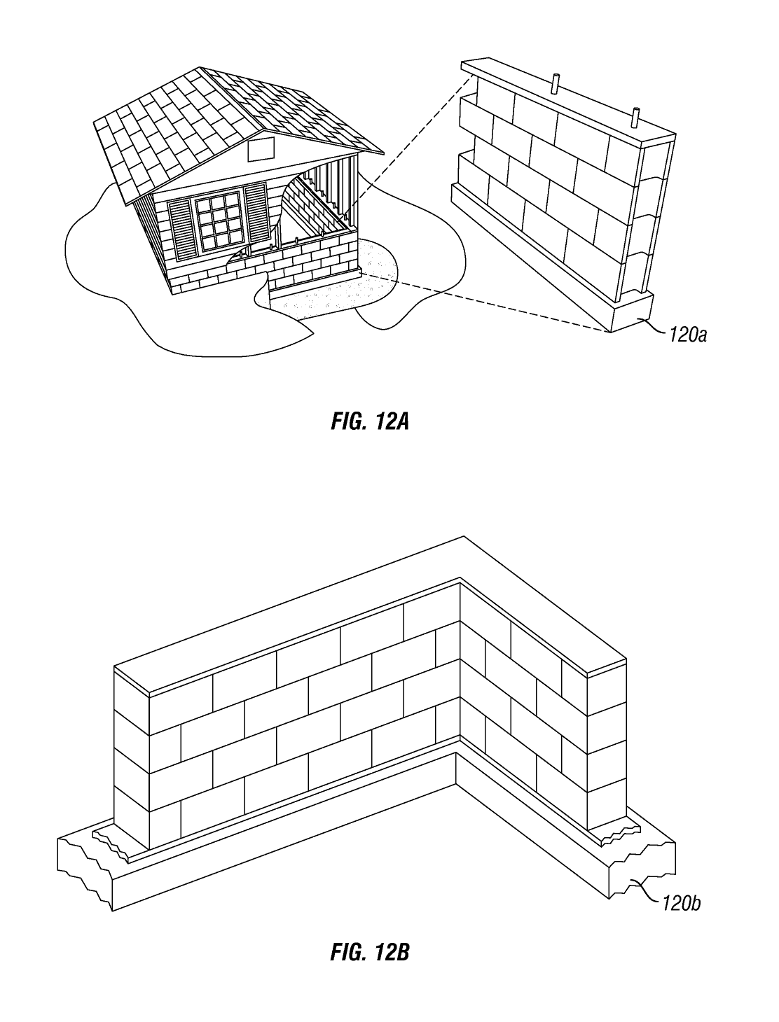

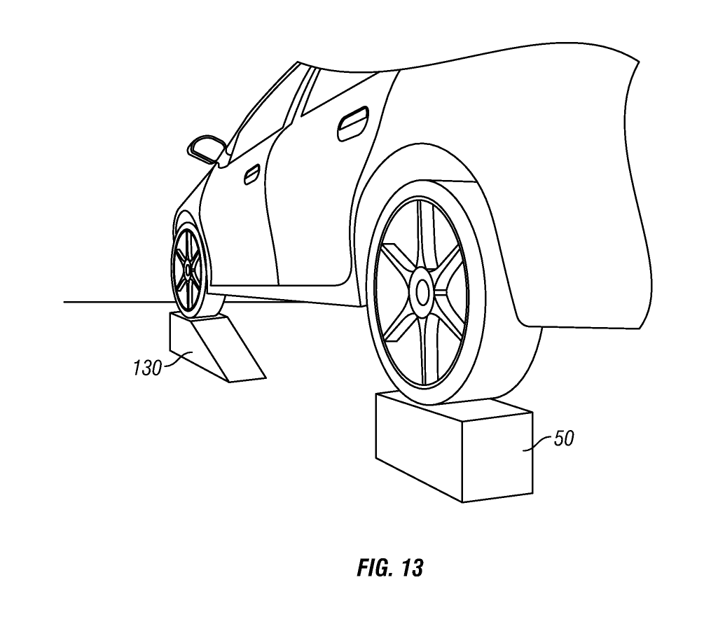

FIGS. 12a and 12b provide further examples for the creation of a house foundation 120a or wall foundation 120b by substituting typical concrete foundation with the encapsulated substrates of the present invention. Finally, FIG. 13 depicts an example of how the present invention can be applied to raising automobiles from the ground surface. One skilled in the art, having read this disclosure, will recognize that a variety of shapes and dimensions are possible with the present invention for the creation of a load-bearing substitute to traditional industry materials that are inherently inferior due to their weight as well as their tendency to absorb harmful substances. Consequently, the figures and fields of art discussed herein are not intended to limit the scope of the invention, rather merely illustrate the capacity and surprising strength of the load-bearing support structure of the present invention. Armed with this disclosure, one skilled in the art will recognize that the present method and its resulting load-bearing and fluid-impervious products can be used in any number of applications. It will be understood by those skilled in the art that various changes in form and detail may be made therein without departing from the scope of the claimed subject matter. Except where otherwise defined, the terms and expressions employed herein have been used as terms of description and not of limitation; and thus, there is no intent of excluding equivalents, but on the contrary it is intended to cover any and all equivalents that may be employed without departing from the spirit and scope of the invention.

What is claimed is:

1. A method for constructing a load-bearing product comprising the steps of:
a) choosing a substrate;
b) designing said substrate as a support for a loaded structure; and
c) coating the substrate with an elastomer.

2. The method of claim 1, wherein said substrate comprises expanded polystyrene.

3. The method of claim 1, wherein said designing step b) comprises forming said substrate into at least one portion.

4. The method of claim 1,wherein said designing step b) comprises designing the substrate as a containment tank base.

5. The method of claim 1, wherein said designing step b) comprises designing the substrate as a stairway.

6. The method of claim 1, wherein said designing step b) comprises designing the substrate as a square pipe stand.

7. The method of claim 1, wherein said designing step b) comprises designing the substrate as a circular pipe stand.

8. The method of claim 1, wherein said designing step b) comprises designing substrate as a pipe support.

9. The method of claim 1, wherein said designing step b) comprises designing the substrate as a separator base.

10. The method of claim 1, wherein said designing step b) comprises designing the substrate as a heater treater support post.

11. The method of claim 1, wherein said coating step c) is performed until the substrate coating is at least approximately 50 mils.

12. The method of claim 1, wherein said load-bearing product is capable of bearing loads of at least about 800 pounds force.

13. The method of claim 1, wherein said coating step c) is performed using a spray device that operates at a temperature of about 165 degrees Fahrenheit.

14. The method of claim 1, wherein said designing step b) comprises forming said substrate into more than one portion to provide said load-bearing support.

15. A load-bearing product comprising a substrate encapsulated by an elastomer, wherein said product comprises a compressive strength of between about 1,056 lbs/sq foot and about 12,500 lbs/sq ft.

16. The load-bearing product of claim 15, wherein said substrate is comprised of expanded polystyrene.

17. The load-bearing product of claim 15, wherein said elastomer comprises polyurea.

18. The load-bearing product of claim 15, wherein said elastomer is at least about 50 mils thick.

19. The load-bearing product of claim 15, wherein said product is capable of continuously supporting a load of at least about 800 pounds.
